(19) United States
(12) Patent Application Publication
(10) Pub. No.: US 2013/0103861 A1
(43) Pub. Date: Apr. 25, 2013

(54) WAKE UP STATE SYNCHRONIZATION METHOD BETWEEN DOCKED TERMINALS AND DOCKING SYSTEM USING THE SAME

(71) Applicants: Byeong-Nam AHN, Seong nam (KR); Syeung-il KIM, Seong nam (KR); Young-Mook CHO, Seong nam (KR)

(72) Inventors: Byeong-Nam AHN, Seong nam (KR); Syeung-il KIM, Seong nam (KR); Young-Mook CHO, Seong nam (KR)

(73) Assignee: HANDONG LNC CO., LTD., Seongnam-si (KR)

(21) Appl. No.: 13/281,403

(22) Filed: Oct. 25, 2011

(51) Int. Cl. G06F 3/00

(52) U.S. Cl. 710/14

(57) ABSTRACT

A state synchronization method between docked terminals and docking system using the same is disclosed. The state synchronization method includes entering by the first terminal into sleep mode operating as a USB host, and entering by the second terminal into sleep mode operating as a USB client; providing by the first terminal a wake up event to the second terminal through a USB interface, when the wake up even occurs by the first terminal; providing by the first terminal a signal through the HDMI interface, and then waiting to be re-connected; and attempting by the second terminal to be re-connected to the first terminal based on the wake up event provided from the first terminal. By this method, it is possible to transmit the wake up event to the other terminal even when a portion of the docked terminals is woken up, enabling both terminals to perform interlocked operations.

### BACKGROUND OF THE INVENTION

1. Field of the Invention

Methods and apparatuses consistent with the exemplary embodiments relate to a wake up state synchronization method between docked terminals and docking system using the same, and more particularly, to a wake up state synchronization method for transmitting a wake up event to the other terminal as well, in the case where a wake up event occurs in one of the docked terminals, and a docking system using the same.

2. Description of the Prior Art

Due to the recent remarkable development of communications technology and popularization of smart phones, a lot of people have smart phones nowadays not merely for telephoning purposes but also for various purposes such as entertainment, writing documents, trading stocks, playing multimedia, and maintaining social relationships etc.

However, a smart phone is equipped with a limited interface device, unlike those used in computers such as mass storage devices, backup devices, and local printers. Moreover, since smart phones are designed with priority consideration given to portability, it is true that the size of display is limited and that the size of buttons and items on a screen is small, making it difficult for a user to manipulate the device quickly and easily.

Therefore, in reality most of the smart phone users perform necessary operations or work through a separate device such as a desktop, notebook, and laptop when they are at home, and use their smart phones only in situations where they cannot use a separate device.

However, if a user is to use an application or environment that he/she used in a smart phone in a separate device once again, there is inconvenience of having to transfer the data stored in the smart phone to the separate device.

In order to increase convenience when using a smart phone which has limited interface device, a docking station for providing an additional input/output interface device is used. When using the docking station, the user is able to use an extension slot, external memory device, dialogue surface display, keyboard, mouse, and local printer, which increases efficiency of operations or work. Furthermore, since the user could use the application and environment that he/she used in the smart phone, the operations or work can be continued.

However, in order to take into account the convenience of users interlocking operation of the docked terminals, the docked terminals must remain interlocked, and it is necessary to prevent one terminal and the other terminal operating differently. One of the cases where such an independent operation may occur is when a wake up event occurs in a situation where a smart phone and a separate device both entered into sleep mode.

In the case where a wake up event occurs in one terminal and thereby only that terminal is woken up and the other terminal is kept in sleep mode, the user has the inconvenience of having to wake up both terminals. And this inconvenience increases when a portion of the docked terminal is located in a rear surface or back surface of the other terminal.

Therefore, there is a need to seek a method for waking up both docked terminals so as to enable interlocked operation of the docked terminals even when a wake up event occurs only in one terminal.

### SUMMARY OF THE INVENTION

The purpose of the present disclosure is to provide a method for synchronizing states of two terminals that are docked on each other in the case where a wake up event occurred in one of the docked terminals by transmitting the wake up event to the other terminals as well.

According to an exemplary embodiment of the present disclosure, a method for synchronizing a state of a second terminal to a state of a first terminal, in the case where the first terminal is docked on the second terminal through a plurality of interfaces, the state synchronization method may include entering by the first terminal into sleep mode operating as a USB host, and entering by the second terminal into sleep mode operating as a USB client; providing by the first terminal a wake up event to the second terminal through a USB interface, when a wake up event is occurred by the first terminal; providing by the first terminal a signal through an HDMI interface, and then waiting to be re-connected; and attempting by the second terminal to be re-connected to the first terminal based on the wake up event provided from the first terminal.

The providing by the first terminal a wake up event may be characterized in that the first terminal turns on a signal transmitted to a USB VBUS line and provides the wake up event to the second terminal, when a wake up event is occurred by the first terminal.

The waiting by the first terminal to be re-connected may be characterized in that the first terminal transmits a TMDS signal to a TMDS data line and waits to be re-connected, and the attempting by the second terminal to be re-connected may include transmitting information that the TMDS signal is transmitted to the TMDS data line to an event controller which manages events occurring when connecting the first terminal and the second terminal; and attempting by the event controller to be re-connected to the first terminal.

According to an exemplary embodiment of the present disclosure, a method for synchronizing a state of a second terminal to a state of a first terminal, in the case where the first terminal is docked on the second terminal through a plurality of interfaces may include entering by the first terminal into sleep mode operating as a USB host, and entering by the second terminal into sleep mode operating as a USB client; providing by the second terminal a wake up event to the first terminal through a HDMI interface, when a wake up event is occurred by the second terminal; turning on by the first terminal a USB VBUS signal based on the wake up event provided from the second terminal, providing data to the second terminal through the HDMI interface, and waiting to be re-connected; and attempting by the second terminal to be re-connected to the first terminal based on data provided from the first terminal.

The providing by the second terminal a wake up event may be characterized in that the second terminal provides the wake up event to the first terminal through a reserved pin of the HDMI interface, when a wake up event is occurred by the second terminal.

The waiting by the first terminal to be re-connected may be characterized in that the first terminal transmits the TMDS signal to the TMDS data line and waits to be re-connected, and the attempting by the second terminal to be re-connected may include transmitting information that the TMDS signal is transmitted to the TMDS data line to an event controller which manages events occurring when connecting the first terminal and the second terminal; and attempting by the event controller to be re-connected to the first terminal.

According to an exemplary embodiment of the present disclosure, a system for synchronizing a state of a second terminal to a state of a first terminal, in the case where the first terminal is docked on the second terminal through a plurality of interfaces, the docking system may include a first terminal which enters into sleep mode operating as a USB host, providing a wake up event to a second terminal through a USB interface when a wake up event is occurred by itself, provides a TMDS signal to the second terminal through a HDMI interface, and waits to be re-connected; and which turns on a USB VBUS signal based on a signal received from the second terminal through a reserved pin of the HDMI interface, providing the second terminal through the HDMI interface, and waiting to be re-connected, when the wake up event is occurred by the second terminal, and a second terminal which enters into sleep mode operating as a USB client, and attempts to be re-connected based on the TMDS signal received from the first terminal through the HDMI interface, when the wake up event is occurred by the first terminal; and which provides the wake up event to the first terminal through the reserved pin of the HDMI interface, when the wake up event is occurred by itself, and attempts the be re-connected based on the TMDS signal received from the first terminal through the HDMI interface.

### BRIEF DESCRIPTION OF THE DRAWINGS

The above and/or other aspects of the present disclosure will be more apparent by describing certain present disclosure with reference to the accompanying drawings, in which:

FIGS. 1 and 2 are views illustrating a docking system where the present disclosure is applicable;

FIG. 3 is a block diagram of the aforementioned docking system;

FIG. 4 is a view partially illustrating an architecture layer under an android platform, as one of application systems which can be used in a smart phone and a smart pad;

FIG. 5 is a flowchart to explain a method for transmitting the wake up event to a smart pad when a wake up event occurs in a smart phone; and

FIG. 6 is a flowchart to explain a method for transmitting the wake up event to a smart phone when a wake up event occurs in a smart pad.

### DETAILED DESCRIPTION

Certain exemplary embodiments are described in higher detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

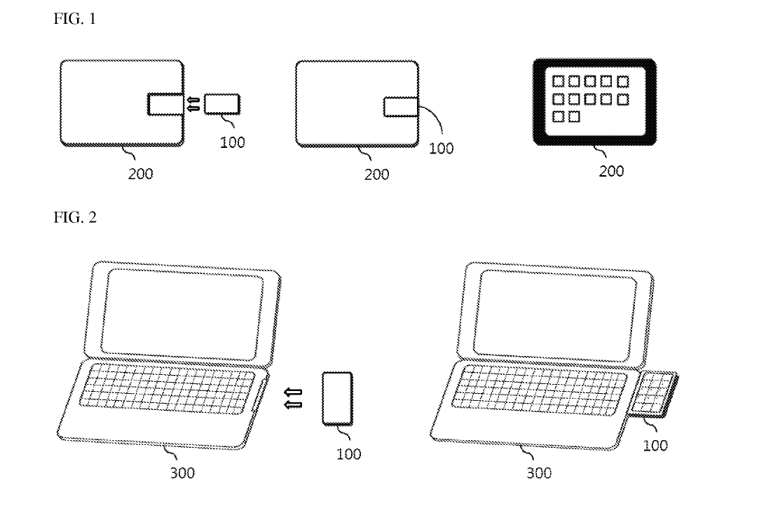

FIGS. 1 and 2 are views illustrating a docking system where the present invention is applicable.

First of all, FIG. 1 is a view illustrating the docking system for interlocking between a smart phone 100 and a smart pad 200. The smart phone 100 and the smart pad 200 may each be operated by separate operation systems, may drive separate application programs, and are equipped with separate devices. Of course, such operation systems and applications may be the same, similar, or different from each other, just as their provided devices may be the same, similar or different from each other.

For example, the smart phone 100 may be operated by an android operation system and drive application programs A, B, and C, while the smart pad 200 is operated by the same android operating system, but drive application programs B, C, and D. Similarly, the smart phone 100 may be equipped with a communications module for phone-calling and a camera module for photo-graphing, while the smart pad 200 is equipped with the same communications module for phone-calling, but also a camera module having higher specifications.

Since the smart phone 100 and the smart pad 200 are equipped with separate operating systems and thus operate according to separate operating systems, if they are not docked to each other as in the first illustration in FIG. 1, they are operated separately by their own operation systems.

However, in the smart phone 100 and the smart pad 200 according to the present disclosure, the smart phone 100 can be docked on a docking station located in a rear surface of the smart pad 200 as illustrated in the second illustration in FIG. 1. Of course, since the docking station is located in the rear surface of the smart pad 200, when using the smart pad 200 with the smart phone 100 docked on the smart pad 200, in order to prevent any input by error manipulation of the smart phone 100, the docking should be done in such a manner that a front surface of the smart phone 100 is not exposed, as in the second illustration in FIG. 1.

The third illustration in FIG. 1 is a screen which is operated by the operating system in the smart phone 100, or operated by the application program installed in the smart phone 100, after the smart phone 100 and the smart pad 200 are docked to each other.

As mentioned above, in the case of docking the smart phone 100 and the smart pad 200 and thereby interlocking the usage of the two terminals, a user is able to continue any operation or work that he/she used to do in the smart phone 100. Not only that, the user is able to use devices such as a display or a high-power speaker of the smart pad 200, which is an advantage of the smart pad 200, improving convenience of the user's operations or work.

Next, FIG. 2 illustrates a docking system for interlocking usage between the smart phone 100 and a laptop 300. The main difference of FIG. 1 from FIG. 2 is that in the docking system of FIG. 2, the smart phone 100 is not docked to be completely inserted into the docking system but is inserted partially into the docking station, enabling the smart phone 100 to function as a number pad for the laptop 300.

Therefore, unlike in FIG. 1, the smart phone 100 is docked on the laptop 300 with its display exposed.

Also by the aforementioned method, in the case of docking the smart phone 100 and the laptop 300 and thereby interlocking the usage of the two terminals, the user becomes able to continue any operation or work that he/she used to do in the smart phone 100 in the laptop 300. Not only that, the user can make use of the advantages of the laptop 300 as well.

Meanwhile, although in FIG. 2 the smart phone 100 is used as the number pad for the laptop 300, this is only an example for the convenience of explaining the present disclosure, and thus the technical concept of the present disclosure can also be applied when the smart phone 100 is used as a general touch pad instead of the number pad.

In addition, although in FIGS. 1 and 2, the smart phone 100 is docked on the smart pad 200 and the laptop 300, respectively, this is also only examples for convenience of explaining the present disclosure, and thus so long as separate terminals are docked to each other, such as the smart pad 200 and the laptop 300 being docked to each other or the smart phone 100 and a desktop (not illustrated) being docked to each other, these are all regarded to be within the scope of applying the present disclosure.

Furthermore, the docking locations or methods of the aforementioned smart phone 100 are also mere examples for the convenience of explaining the present disclosure, and thus the present disclosure could also be applied to cases of dockings by other methods and in locations not illustrated herein.

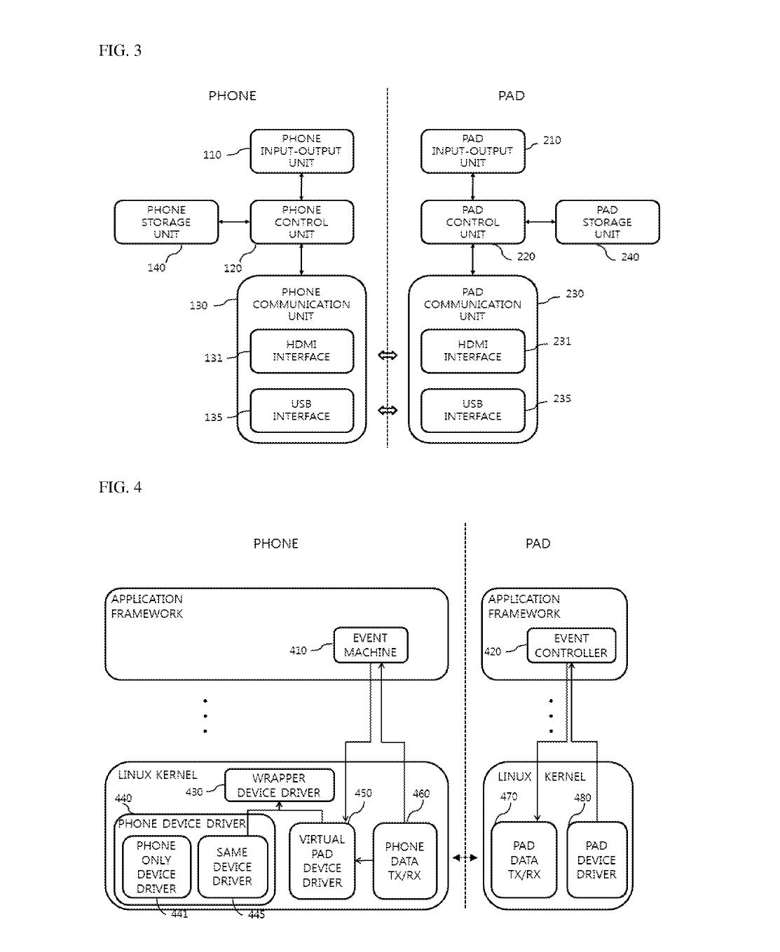

FIG. 3 is a block diagram of the aforementioned docking system. Hereinafter for convenience of explaining the present disclosure, the supposition will be that the smart phone 100 and the smart pad 200 are docked and interlocked to each other.

The smart phone 100 comprises a phone input-output unit 110, a phone control unit 120, a phone communication unit 130 and a phone storage unit 140.

The phone input-output unit 110 is used for the purpose of receiving signals input from a user or an external server or a terminal such as a touch screen, a button, and a speaker, and displaying the received signals on a screen or outputting them as voice.

The phone control unit 120 controls the phone input-output unit 110, the phone communication unit 130, and the storage unit 140 in such manners that the smart phone 100 can perform its functions properly. Especially, the phone control unit 120 controls the phone input-output unit 110 to process signals or user inputs received, and to display or output the processed results through the phone input-output unit 110. In addition, the phone control unit 120 controls the phone communication unit 130 to enable information exchange and data transmission and reception between the smart phone 100 and the smart pad 200. Not only that, the phone control unit 120 controls the phone storage unit 140 to store data transmitted to the phone input-output unit 100 and data transmitted and received through the phone communication unit 130, or to display data stored in the phone storage unit 140 through the phone input-output unit 110 or to transmit data to the smart pad 200.

Furthermore, the phone control unit 120 controls so that the smart phone 100 is implemented according to an operating system or an application program stored in the phone storage unit 140.

In addition, the phone control unit 120 controls each device of the smart pad 200 to operate according to the operating system or the application program implemented in the smart phone 100, in the case where the smart phone 100 is docked on the smart pad 200.

For example, in the case where the smart phone 100 is docked on the smart pad 200, the phone control unit 120 controls the phone input-output unit 110 to be inactivated, that the input-output data is transmitted to the smart pad 200 through the phone communication unit 140 and is input-output in the smart pad 200.

The phone communication unit 130 operates as a means to communicate with the smart pad 200 or an external terminal, under the control of the phone control unit 120. Especially, the phone communication unit 130 is equipped with an HDMI interface 131 and a USB interface 135, and transmits/receives data and signals by communicating with the smart pad 200. A process of transmitting sleep events between the smart phone 100 and the smart pad 200 using the HDMI interface 131 and the USB interface 135, and entering both terminals into wake up mode together will be explained in more detail hereinafter.

The phone storage unit 150 stores operating systems or application programs for driving the smart phone 100.

As aforementioned, through the HDMI interface 131 and USB interface 135 provided in the phone communication unit 130, the smart phone 100 enables screens or voices generated in the smart phone 100 to be displayed or output in the smart pad 200.

Meanwhile, the smart pad 200 comprises a pad input-output unit 210, a pad control unit 220, a pad communication unit 230, and a pad storage unit 240.

Hereinafter the explanation will be focusing on the operations in the case where the smart phone 100 is docked on the smart pad 200.

The pad control unit 220 controls the pad communication unit 230 to enable information exchange and data transmitting/receiving between the smart phone 100 and the smart pad 200. Not only that, the pad control unit 220 controls the pad storage unit 240 to store data received from the smart phone 100 through the pad communication unit 240 or to transmit data stored in the pad storage unit 240 to the smart phone 100.

In the case where the smart phone 100 is docked on the smart pad 200, the pad control unit 220 controls each device of the smart pad 200 to operate according to operating systems and application programs implemented in the smart phone 100.

When the smart pad 200 is not interlocked to the smart phone 100, the smart pad 200 is operated by its separate operating system, but when the smart pad 200 is interlocked to the smart phone 100, the smart pad 200 receives data regarding the operations by the operating system of the smart phone 100 from the smart phone 100 through the pad communication unit 230 and provides the data to the user.

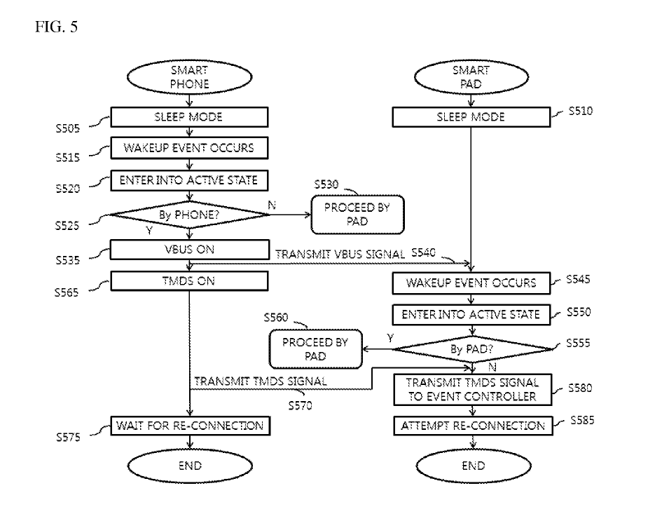

FIG. 4 partially illustrates an architecture layer under an android platform, which is one of the application systems that can be used in the smart phone 100 and the smart pad 200. The android operating system is stored in the phone storage unit 140 of the smart phone 100 and the pad storage unit 240 of the smart pad 200, enabling the smart phone 100 and the smart pad 200 to operate according to the android operating system stored in the smart phone 100 and the smart pad 200.

The android platform refers to a software package which includes a Linux Kernel, HAL(Hardware Abstraction Layer), Library, application framework, and application, and hereinafter, the explanation will focus on the application framework layer and the Linux Kernel layer which are necessary portions in understanding the present disclosure.

The application framework layer is a layer just below the uppermost layer, the application layer. In the application framework layer, there are various controllers in demon forms and the controllers manage the operating system. Especially in such an application framework, there is an event machine 410 or an event controller 420.

The event machine 410 which operates in the application framework layer of the smart phone 100 manages a wrapper device driver 430 which will be explained in detail hereinafter and performs the role of managing the events that occur in the smart phone 100 when the smart phone 100 and the smart pad 200 are connected to each other.

In addition, the event controller 420 which operates in the application framework layer of the smart pad 200 performs the role of managing the events that occur in the smart pad 200 when the smart phone 100 and the smart pad 200 are connected to each other.

The lowermost layer is the Linux Kernel layer. Various drivers such as a display driver, a camera driver, and an audio driver are included in the Linux Kernel layer, and the Linux Kernel takes the role of an abstraction layer among the remaining layers of the hardware and the android platform stack.

Meanwhile, the Linux Kernel layer of the smart phone 100 includes a Phone Only Device Driver 441 which is a driver for the devices that exist only in the smart phone 100, and a same device driver 445 which is a driver for the devices that exist both in the smart phone 100 and the smart pad 200.

In addition, in the case where the smart phone 100 already knows a device list of the smart pad 200, the smart phone 100 generates a Virtual Pad Device Driver 450 regarding those devices, and the wrapper device driver 430 manages the interlocked operations of the smart phone 100 by supervising the same device driver 445 and the Virtual Pad Device Driver 450 together.

Meanwhile, data transmission/reception between the smart phone 100 and the smart pad 200 is made through a phone data TX/RX 460 and a PAD data TX/RX 470, which are the same concepts of the aforementioned phone communication unit 130 and the pad communication unit 230, respectively.

Hereinabove the supposition was that the event machine 410 and the event controller 420 exist in the application framework layer, but that was merely for the convenience of explaining the present disclosure. Thus, the technical concept of the present disclosure would also apply to the cases where the event machine 410 and the event controller 420 exist in other layers of the upper layers of the Kernel layer not only in the framework layer. The present disclosure would also apply to the case where the event machine 410 and the event controller 420 exist in the Kernel layer as well.

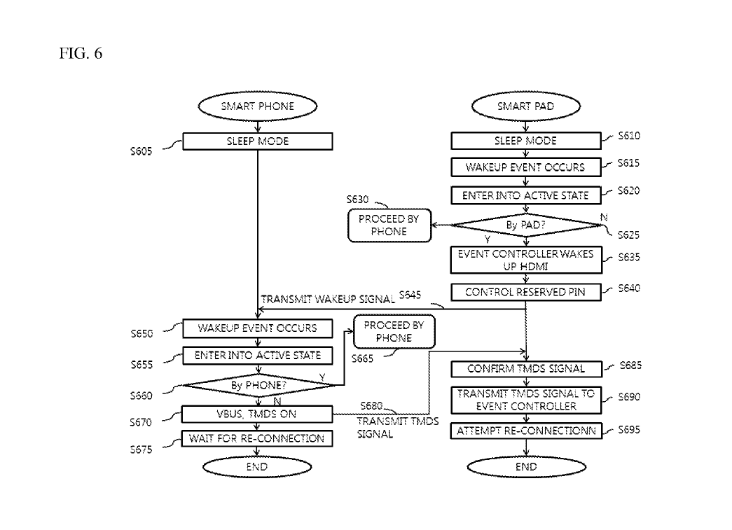

Referring to FIGS. 5 and 6, hereinafter is an explanation of a process where the smart phone 100 and the smart pad 200 are converted from sleep mode into wake up mode together.

FIG. 5 is a flowchart for explaining a method for transmitting the wake up event to the smart pad 200 when a wake up event occurs in the smart phone 100.

First of all, in order to transmit a wake up event, the smart phone 100 and the smart pad 200 need to be kept in sleep mode (S505, S510). Especially, the smart phone 100 is kept in sleep mode as a USB host, while the smart pad 200 is kept in sleep mode as a USB client. This is because the smart phone 100 has to be the USB host in order to transmit USB VBUS signals to the smart pad 200, as will be explained in more detail hereinafter.

When a wake up event occurs in the smart phone 100 (S515), the smart phone 100 enters into active state (S520). In this active state, the smart phone 100 determines the route in which the wake up event occurred. In the case where a wake up event is occurred by the smart phone 100 itself such as telephone ringing or alarm going off (S525-Y), since the smart phone 100 is in a USB host state, it turns the VBUS on (S535) and transmits a VBUS signal to the smart pad 200 (S540).

Meanwhile, in the case where a wake up event is occurred by not the smart phone 100 but the smart pad 200 (S525-N), the smart phone 100 and the smart pad 200 go through the process of the wake up event occurred by the smart pad 200 (S530), which will be explained hereinafter referring to FIG. 6.

When the smart pad 200 receives the VBUS signal, based on that VBUS signal, the smart pad 200 becomes aware that a wake up event occurred (S545), and accordingly, the smart pad 200 enters into active state (S550).

As in the smart phone 100, the smart pad 200 also determines the route in which the wake up event occurred. In the case where a wake up event is occurred by the smart pad 200 such as telephone ringing or alarm going off (S560-Y), the smart phone 100 and the smart pad 200 go through the process of the wake up event occurred by the smart pad 200 (S560). This will be explained in more detail with reference to FIG. 6 hereinafter.

Meanwhile, the smart phone 100 turns a TMDS on (S565), transmits the TMDS signal to the smart pad 200 (S570), and waits to be re-connected to the smart pad 200 (S575), while the smart pad 200 transmits the TMDS signal received to the event controller 420 (S580), and attempts to be re-connected to the smart phone 100 (S585).

By the aforementioned, it is possible to prevent waking up the smart phone 100 alone while the smart pad 200 is kept in sleep mode, when a wake up event occurs in the smart phone 100. Accordingly, the smart phone 100 and the smart pad 200 are interlocked and can be woken up together, needless to wake up each terminal one by one.

FIG. 6 is a flowchart for explaining a method for transmitting the wake up event to the smart phone 100 when a wake up event occurs in the smart pad 200.

First of all, in order to transmit a wake up event, the smart phone 100 and the smart phone 200 need to be kept in sleep mode (S605, S610). Especially, the smart phone 100 is kept in sleep mode as a USB host, while the smart pad 200 is kept in sleep mode as a USB client.

When a wake up event occurs in the smart pad 200 (S615), the smart pad 200 enters into active state (S620). In this active state, the smart pad 200 determines the route in which the wake up event occurred.

In the case where the wake up event is occurred by not the smart pad 200 but the smart phone 100 (S625-N), the smart phone 100 and the smart pad 200 go through the process of the wake up event occurred by the smart phone 100 (S630). Please refer to FIG. 5 aforementioned.

On the other hand, in the case where a wake up event is occurred by the smart pad 200 itself (S625-Y), the event controller 420 wakes up the HDMI interface (S635) and controls a reserved pin (S640). That is, the smart pad 200 transmits the wake up signal to the smart phone 100 through the reserved pin of the HDMI interface woken up (S645).

The smart phone 100 receives the wake up signal through the reserved pin and becomes aware that the wake up event occurred (S650), and accordingly, the smart phone 100 enters into active state (S655).

As in the smart pad 200, the smart phone 100 also determines the route in which the wake up event occurred (S660). In the case where the wake up event occurred by the smart phone 100 itself such as telephone ringing or alarm going off (S660-Y), the smart phone 100 and the smart pad 200 go through the process of the wake up event occurred by the smart phone 100 (S665). Please refer to FIG. 5 aforementioned.

Meanwhile, in the case where the wake up event is occurred by the smart pad 200 (S660-N), the smart phone 100 turns the VBUS and TMDS on (S670), transmits the TMDS signal to the smart pad 200 through the TMDS data line (S680), and waits to be re-connected to the smart pad 100 (S575), while the smart pad 200 confirms the TMDS signal received (S685) and transmits the TMDS signal received to the event controller 420 (S690), and attempts to be re-connected to the smart phone 100 (S695).

By the aforementioned, it is possible to prevent waking up the smart pad 200 alone while the smart phone 100 is kept in sleep mode, when a wake up event occurs in the smart pad 200. Accordingly, the smart phone 100 and the smart pad 200 are interlocked and can be woken up together, needless to wake up each terminal one by one.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method for synchronizing a state of a second terminal to a state of a first terminal, in the case where the first terminal is docked on the second terminal through a plurality of interfaces, the state synchronization method comprising:
entering by the first terminal into sleep mode operating as a USB host, and entering by the second terminal into sleep mode operating as a USB client;
providing by the first terminal a wake up event to the second terminal through a USB interface, when a wake up event is occurred by the first terminal;
providing by the first terminal a signal through an HDMI interface, and then waiting to be re-connected; and
attempting by the second terminal to be re-connected to the first terminal based on the wake up event provided from the first terminal.

2. The method as claimed in claim 1, the providing by the first terminal a wake up event is characterized in that the first terminal turns on a signal transmitted to a USB VBUS line and provides the wake up event to the second terminal, when a wake up event is occurred by the first terminal.

3. The method as claimed in claim 1, the waiting by the first terminal to be re-connected is characterized in that the first terminal transmits a TMDS signal to a TMDS data line and waits to be re-connected, and the attempting by the second terminal to be re-connected comprises:
transmitting information that the TMDS signal is transmitted to the TMDS data line to an event controller which manages events occurring when connecting the first terminal and the second terminal; and
attempting by the event controller to be re-connected to the first terminal.

4. A method for synchronizing a state of a second terminal to a state of a first terminal, in the case where the first terminal is docked on the second terminal through a plurality of interfaces, the state synchronization method comprising:
entering by the first terminal into sleep mode operating as a USB host, and entering by the second terminal into sleep mode operating as a USB client;
providing by the second terminal a wake up event to the first terminal through a HDMI interface, when a wake up event is occurred by the second terminal;
turning on by the first terminal a USB VBUS signal based on the wake up event provided from the second terminal, providing data to the second terminal through the HDMI interface, and waiting to be re-connected; and
attempting by the second terminal to be re-connected to the first terminal based on data provided from the first terminal.

5. The method as claimed in claim 1, wherein the providing by the second terminal a wake up event is characterized in that the second terminal provides the wake up event to the first terminal through a reserved pin of the HDMI interface, when a wake up event is occurred by the second terminal.

6. The method as claimed in claim 1, wherein the waiting by the first terminal to be re-connected is characterized in that the first terminal transmits the TMDS signal to the TMDS data line and waits to be re-connected, and the attempting by the second terminal to be re-connected comprises:
transmitting information that the TMDS signal is transmitted to the TMDS data line to an event controller which manages events occurring when connecting the first terminal and the second terminal; and
attempting by the event controller to be re-connected to the first terminal.

7. A system for synchronizing a state of a second terminal to a state of a first terminal, in the case where the first terminal is docked on the second terminal through a plurality of interfaces, the docking system comprising:
a first terminal which enters into sleep mode operating as a USB host, providing a wake up event to a second terminal through a USB interface when a wake up event is occurred by itself, provides a TMDS signal to the second terminal through a HDMI interface, and waits to be re-connected; and which turns on a USB VBUS signal based on a signal received from the second terminal through a reserved pin of the HDMI interface, providing the second terminal through the HDMI interface, and waiting to be re-connected, when the wake up event is occurred by the second terminal, and
a second terminal which enters into sleep mode operating as a USB client, and attempts to be re-connected based on the TMDS signal received from the first terminal through the HDMI interface, when the wake up event is occurred by the first terminal; and which provides the wake up event to the first terminal through the reserved pin of the HDMI interface, when the wake up event is occurred by itself, and attempts the be re-connected based on the TMDS signal received from the first terminal through the HDMI interface.
